(19) United States
(12) Patent Application Publication
(10) Pub. No.: US 2015/0317539 A1
(43) Pub. Date: Nov. 5, 2015

(54) IMAGE RECOGNITION SYSTEM WITH ASSISTANCE OF MULTIPLE LENSES AND METHOD THEREOF

(71) Applicant: Altek Semiconductor Corporation, Hsinchu City (TW)

(72) Inventor: Hong-Long CHOU, Taipei City (TW)

(21) Appl. No.: 14/305,582

(22) Filed: Jun. 16, 2014

(30) Foreign Application Priority Data
Apr. 30, 2014 (TW) 103115511

(51) Int. Cl. G06K 9/62; G06T 7/00

(52) U.S. Cl. CPC G06K 9/6214; G06T 7/0022; G06K 9/6211; G06T 2207/10004; G06T 2207/20221

(57) ABSTRACT

The present disclosure illustrates an image recognition system with assistance of the multiple lenses. The system is characterized in using an image capturing device having dual lenses to calculate 3D data of an object, and the 3D data includes spacial coordinates corresponding to multiple parts of the object image. The object image exists in both of the first image and the second image, and corresponds to the object.

### CROSS-REFERENCE TO RELATED APPLICATION

This application claims the benefit of Taiwan Patent Application No. 103115511, filed on Apr. 30, 2014, in the Taiwan Intellectual Property Office, the disclosure of which is incorporated herein in its entirety by reference.

### BACKGROUND OF THE INVENTION

1. Field of the Invention

The present disclosure relates to an image recognition system, more particularly, to an image recognition system using the three dimensional information to assist recognition.

2. Description of the Related Art

At present, the image recognition technology is widely applied in various fields. For example, the face recognition technology is applied in the field of security, and the characters recognition technology is applied in the field of data input.

Please refer to FIG. 1 which is a schematic view of a business card recognition system in prior art. Because of the shooting angle, a captured business card image 99 is not a standard rectangular shape, but a trapezoid, as shown in FIG. 1. In order to improve precision of recognition, the business card recognition system in prior art converts the captured business card image 99 to a rectangular shape, and also performs a deformation transformation on the content of business card image 99. After the transformation, the business card recognition system performs the characters recognition on the transformed image.

However, the deformation transformation of the business card recognition system in prior art is only workable on the rectangular object to be recognized. However, the user also need to recognize the characters, patterns or faces on the objects with various shapes, but deformation transformation of the business card recognition system in prior art cannot meet the demand.

### SUMMARY OF THE INVENTION

To solve the above-mentioned problem, one of objectives of the present disclosure is to provide an image recognition system with assistance of the multiple lenses, to recognize the content on the objects in different shapes.

To solve the above-mentioned problem, other objective of the present disclosure is to provide an image recognition system with assistance of the multiple lenses, to improve precision of the recognition efficiently.

An exemplary embodiment of the present disclosure provides an image recognition system with assistance of the multiple lenses, and the system is adapted for an image capture device having a first lens and a second lens. The image recognition system comprises a coordinate calculation module, an orientation transformation module and an image recognition module. The coordinate calculation module receives a first image and a second image from the first lens and the second lens, and calculates a plurality of spacial coordinates of multiple parts of an object image according to the first image and the second image. The object image exists in the first image and the second image respectively and corresponds to an object. The orientation transformation module performs an orientation transformation according to the multiple spacial coordinates to make an orientation of the object toward the image capturing device for generating a transformed object image. The image recognition module performs an image recognition process on the transformed object image to generate a recognition result.

Preferably, each of the parts is a pixel, or each of the parts comprises a plurality of pixels.

Preferably, the orientation transformation module calculates a normal vector of the object according to the plurality of spacial coordinates, and calculates a plurality of angle differences between the normal vector and an optical axis direction of the first lens or the second lens, and performs the transformation according to the plurality of angle differences to align the normal vector with the optical axis direction, and generates the transformed object image correspondingly.

Preferably, the image recognition system of the present disclosure further comprises an object flattening module to perform a flattening process on the object according to the plurality of spacial coordinates, and generates a flattened object image correspondingly. The image recognition module then performs the image recognition process on the flattened object image to generate the recognition result.

Preferably, the image recognition system of the present disclosure further comprises a portion selection module to provide a user to select a potion to be flattened in the first image or the second image.

Preferably, the image recognition process comprises a character recognition process, a pattern recognition process, or a face recognition process.

An exemplary embodiment of the present disclosure provides an image recognition method with assistance of multiple lenses, and the method is adapted for an image capture device having a first lens and a second lens. The image recognition method comprises following steps of: using the first lens and the second lens to capture a first image and a second image, respectively; calculating a plurality of spacial coordinates of multiple parts of an object image according to the first image and the second image, the object image existing in the first image and the second image respectively and corresponding to an object; performing an orientation transformation according to the spacial coordinates to make the orientation of the object toward the image capturing device, and generating a transformed object image correspondingly; performing an image recognition process on the transformed object image to generate a recognition result.

Preferably, the image recognition method of the present disclosure further comprises steps of: calculating a normal vector of the object according to the spacial coordinates, and calculating a plurality of angle differences between the normal vector and an optical axis direction of the first lens or the second lens; performing a transform according to plurality of angle differences to align normal vector with the optical axis direction, and generating the transformed object image correspondingly.

Preferably, the image recognition method of the present disclosure further comprises steps of performing a flattening process on the object according to the plurality of spacial coordinates and generating a flattened object image correspondingly; performing the image recognition process on the flattened object image to generate the recognition result.

Preferably, the image recognition process comprises a character recognition process, a pattern recognition process, or a face recognition process.

To sum up, the image recognition system with assistance of the multiple lenses and the method thereof of the present disclosure have at least one of the following advantages.

First, the image recognition system with assistance of the multiple lenses and the method thereof of the present disclosure can recognize characters, patterns or faces on objects in various shapes.

Second, the image recognition system with assistance of the multiple lenses and method thereof of the present disclosure can be adapted for the object having a folded surface or a deformed surface, particularly for the cloth object. The image recognition system of the present disclosure can flatten such object before the recognition, so as to improve recognition precision.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic view of a business card recognition system in the prior art.

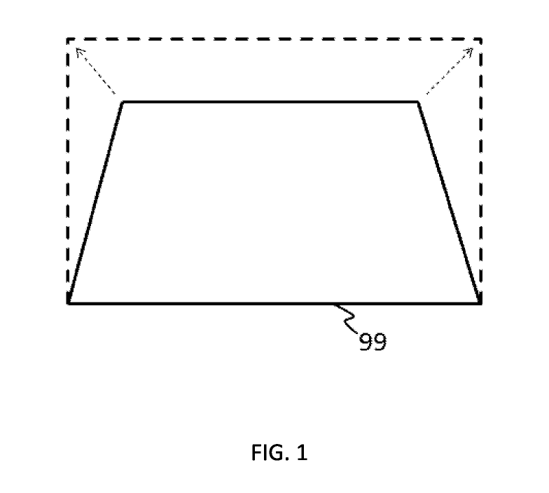

FIG. 2 is a block diagram of a first embodiment of an image recognition system with assistance of multiple lenses of the present disclosure.

FIG. 3 is a schematic view of the first embodiment of an image recognition system with assistance of first multiple lenses of the present disclosure.

FIG. 4 is a second schematic view of the first embodiment of the image recognition system with assistance of multiple lenses of the present disclosure.

FIG. 5 is a block diagram of a second embodiment of the image recognition system with assistance of multiple lenses of the present disclosure.

FIG. 6 is a flow diagram of a first embodiment of an image recognition method with assistance of multiple lenses of the present disclosure.

FIG. 7 is a flow diagram of a second embodiment of the image recognition method with assistance of multiple lenses of the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

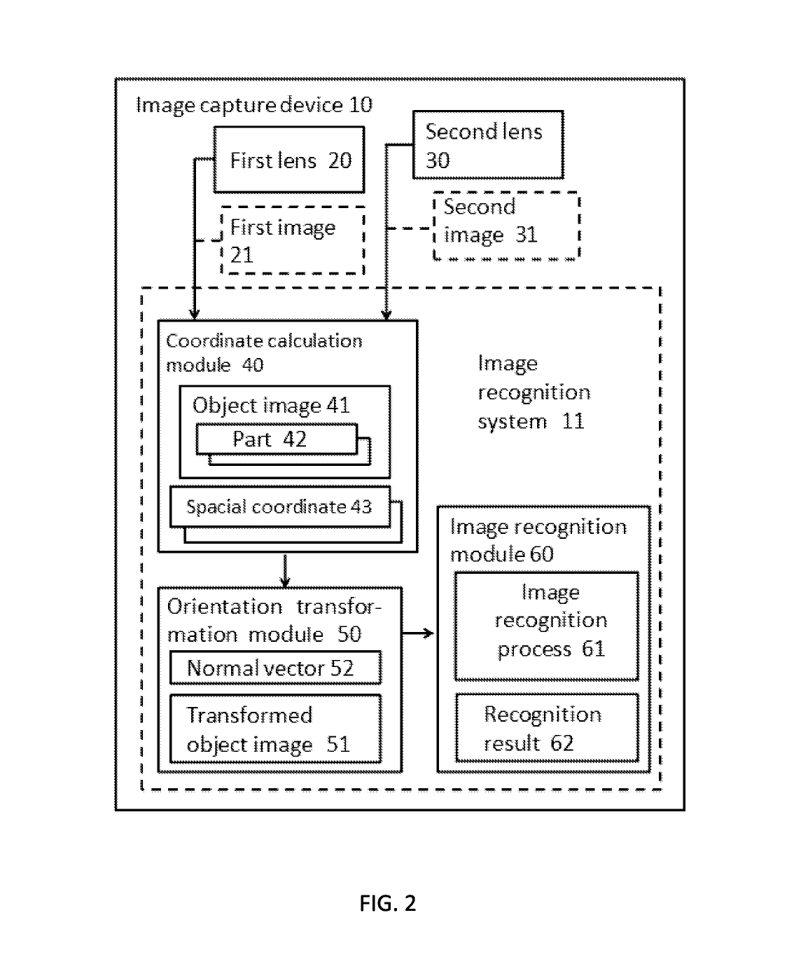

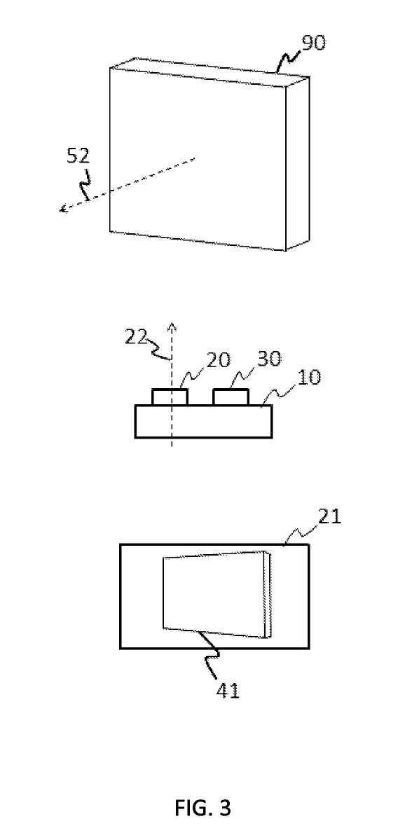

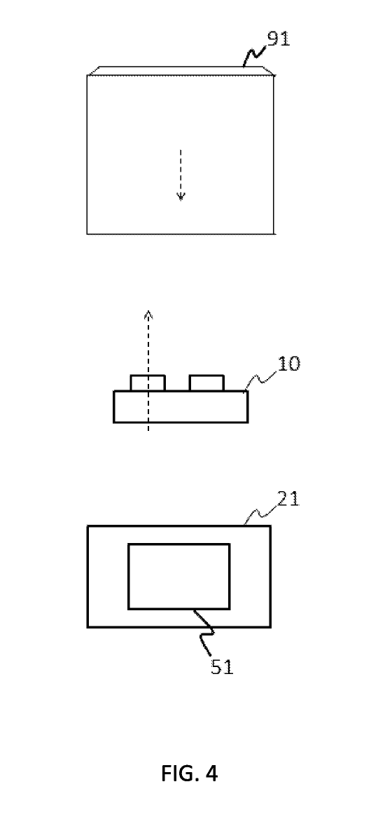

Please refer to FIG. 2, FIG. 3 and FIG. 4. The FIG. 2 is a block diagram of a first embodiment of an image recognition system with assistance of the multiple lenses of the present disclosure, and the FIG. 3 and FIG. 4 are first schematic view and schematic view, respectively. The image recognition system 11 is adapted for an image capture device 10 having a first lens 20 and a second lens 30, and comprises a coordinate calculation module 40, an orientation transformation module 50, and an image recognition module 60.

The coordinate calculation module 40 receives a first image 21 and a second image 31 from the first lens 20 and the second lens 30, and calculates a plurality of spacial coordinates 43 of multiple parts 42 of an object image 21 according to the first image 21 and the second image 31. The object image 41 exists in the first image 21 and the second image 31 respectively and corresponds to an object 90.

In the image recognition system 11, it is noted that the object 90 is a group consisted of multiple points of the plurality of spacial coordinates 43, and the object 90 corresponds to a physical object being shot in the external environment. In implementation, each part 42 can be a pixel and the image recognition system 11 requires more computation power but can generate the object 90 with higher resolution; or each part 42 can comprise a plurality of pixels.

The orientation transformation module 50 performs an orientation transformation according to the multiple spacial coordinates 43 to rotate the object 90, whereby an orientation of the object 90 is directed toward the image capturing device 10 to generate a transformed object image 51. In implementation, the orientation transformation module 50 calculates a normal vector 52 of the object 90 according to the plurality of spacial coordinate 43, as shown in FIG. 3.

The orientation transformation module 50 then calculates a plurality of angle differences the between a normal vector 52 and an optical axis direction 22 of the first lens 20 or the second lens 30, and then performs the transformation according to the plurality of angle differences to align the normal vector 52 of the transformed object 91 with the optical axis direction 22, and generates a transformed object image 51 correspondingly, as shown in FIG. 4. The orientation transformation process and corresponding image process is well known by the skilled persons in this field, so detailed description is omitted. Any technology related to the orientation transformation process and corresponding image process can be applied to the present disclosure, and it is not limited to the exemplary embodiments.

The image recognition module 60 performs an image recognition process 61 on the transformed object image 51 to generate a recognition result 62. In implementation, the image recognition process 61 comprises a character recognition process, a pattern recognition process, or a face recognition process, and any recognition technology can be applied to the present disclosure. Because the orientation transformation module 50 rotates the object 90 to be recognized toward the front direction in advance, the recognition precision can become higher.

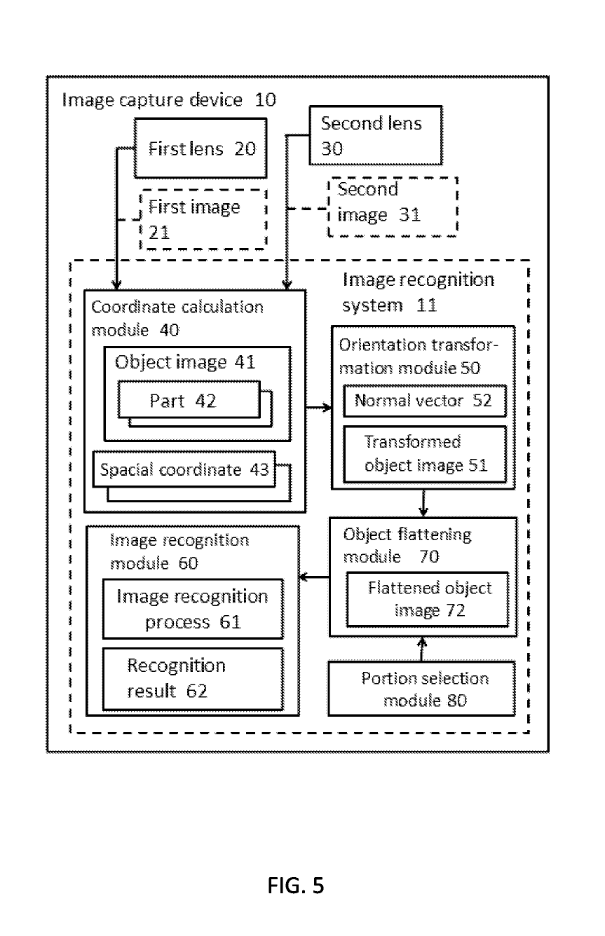

Please refer to FIG. 5 which is a block diagram of a second embodiment of the image recognition system with assistance of multiple lenses of the present disclosure. The difference between the second embodiment and the first embodiment is that the image recognition system 12 further comprises an object flattening module 70 and a portion selection module 80.

Before recognition, the object flattening module 70 performs a flattening process on the object 90 according to the plurality of spacial coordinates 43, and generates a flattened object image 72 correspondingly. The image recognition module 60 then performs the image recognition process 61 on the flattened object image 72 to generate the recognition result 62.

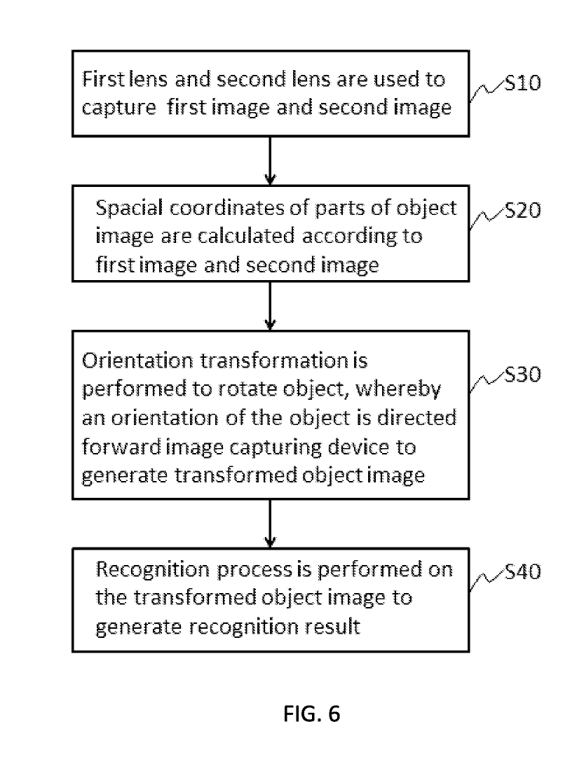

Please refer to FIG. 6 which is a flow diagram of a first embodiment of the image recognition method with assistance of multiple lenses of the present disclosure. The second embodiment is illustrated by cooperating with the image recognition system 11 of the FIG. 2. The image recognition method comprises following steps. In step S10, the first lens 20 and the second lens 30 are used to capture a first image 21 and a second image 31, respectively.

In step S20, a plurality of spacial coordinates 43 of multiple parts 42 of an object image 21 are calculated according to the first image 21 and the second image 31. The object image 41 exists in the first image 21 and the second image 31 respectively and corresponds to an object 90.

In step S30, an orientation transformation is performed according to the multiple spacial coordinates 43 to rotate the object 90, whereby an orientation of the object 90 is directed toward the image capturing device 10 to generate a transformed object image 51.

In step S40, a recognition process 61 is performed on the transformed object image 51 to generate a recognition result 62.

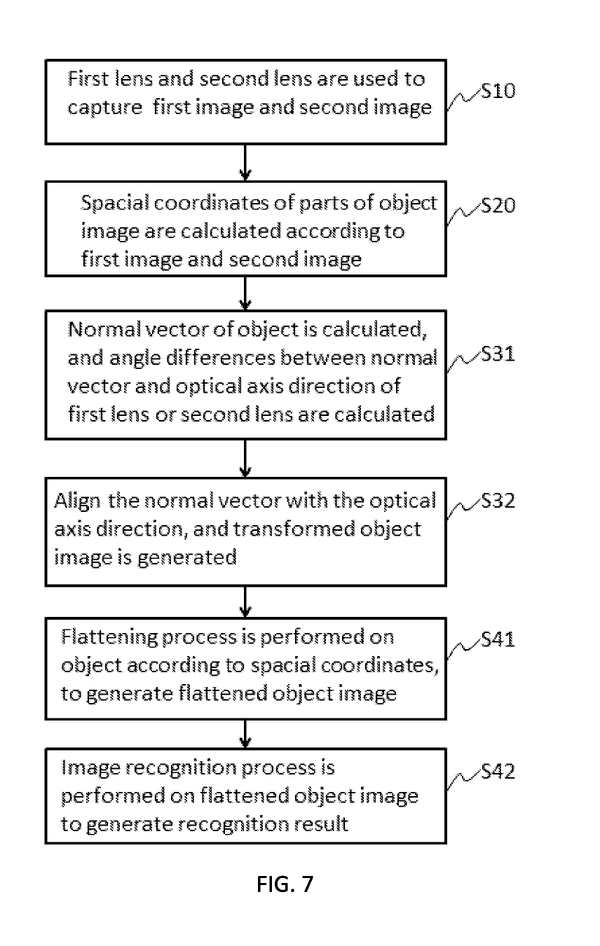

Please refer to FIG. 7 which is a flow diagram of a second embodiment of the image recognition method with assistance of multiple lenses of the present disclosure. The second embodiment is illustrated by cooperating with the image recognition system 12 of the FIG. 4. The image recognition method comprises following steps. In step S10, the first lens 20 and the second lens 30 are used to capture a first image 21 and a second image 31, respectively.

In step S20, a plurality of spacial coordinates 43 of multiple parts 42 of an object image 21 are calculated according to the first image 21 and the second image 31. The object image 41 exists in the first image 21 and the second image 31 respectively and corresponds to an object 90.

In step S31, a normal vector 52 of the object 90 is calculated according to the plurality of spacial coordinates 43, and a plurality of angle differences between the normal vector 52 and an optical axis direction 22 of the first lens 20 or the second lens 30 are calculated. In step S32, a transform is performed according to plurality of angle differences to align the normal vector 52 with the optical axis direction, and a transformed object image 51 is generated correspondingly.

In step S41, a flattening process is performed on the object 90 according to the plurality of spacial coordinate 43, to generate a flattened object image 72 correspondingly. In step S42, the image recognition process 61 is performed on the flattened object image 72 to generate the recognition result 62.

To sum up, the image recognition system with assistance of the multiple lenses and the method thereof of the present disclosure can recognize characters, patterns or faces on objects in various shapes. In addition, the image recognition system with assistance of the multiple lenses and method thereof of the present disclosure can be adapted for the object having a folded surface or a deformed surface, in particular to the cloth object. The image recognition system can flatten such object first and then perform recognition, so as to improve precision of recognition.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An image recognition system with assistance of multiple lenses, adapted for an image capture device having a first lens and a second lens, and the image recognition system comprising:
a coordinate calculation module, configured for receiving a first image and a second image from the first lens and the second lens, and calculating a plurality of spacial coordinates of multiple parts of an object image according to the first image and the second image, the object image existing in the first image and the second image respectively and corresponding to an object;
an orientation transformation module, configured for performing orientation transform according to the plurality of spacial coordinates, to make the orientation of the object toward the image capture device for generating a transformed object image; and
an image recognition module, configured for performing an image recognition process on the transformed object image to generate a recognition result.

2. The image recognition system of claim 1, wherein each of the plurality of parts is a pixel, or each of the plurality of parts comprises a plurality of pixels.

3. The image recognition system of claim 1, wherein the orientation transformation module calculates a normal vector of the object according to the plurality of spacial coordinates, and calculates a plurality of angle differences between the normal vector and an optical axis direction of the first lens or the second lens, and then aligns the normal vector with the optical axis direction according to the plurality of angle differences, and generates the transformed object image correspondingly.

4. The image recognition system of claim 1, further comprising an object flattening module configured for performing a flattening process on the object according to the plurality of spacial coordinates and generating a flattened object image correspondingly, wherein the image recognition module then performs the image recognition process on the flattened object image to generate the recognition result.

5. The image recognition system of claim 4, further comprising a portion selection module configured for providing a user to select a potion to be flattened in the first image or the second image.

6. The image recognition system of claim 1, wherein the image recognition process comprises a character recognition process, a pattern recognition process, or a face recognition process.

7. An image recognition method with assistance of multiple lenses, adapted for an image capture device having a first lens and a second lens, and the image recognition method comprising:
using the first lens and the second lens to capture a first image and a second image, respectively;
calculating a plurality of spacial coordinates of multiple parts of an object image according to the first image and the second image, the object image existing in the first image and the second image respectively and corresponding to an object;
performing an orientation transformation according to the multiple spacial coordinates to make the orientation of the object toward the image capturing device for generating a transformed object image; and
performing an image recognition process on the transformed object image to generate a recognition result.

8. The image recognition method of claim 7, further comprising:
calculating a normal vector of the object according to the plurality of spacial coordinates, and calculating a plurality of angle differences between the normal vector and an optical axis direction of the first lens or the second lens; and
aligning the normal vector with the optical axis direction according to the plurality of angle differences, and generating the transformed object image correspondingly.

9. The image recognition method of claim 7, further comprising:
performing a flattening process on the object according to the plurality of spacial coordinate and generating a flattened object image correspondingly; and
performing the image recognition process on the flattened object image to generate the recognition result.

10. The image recognition method of claim 7, wherein the image recognition process comprises a character recognition process, a pattern recognition process, or a face recognition process.
